(19) United States
(12) Patent Application Publication
(10) Pub. No.: US 2009/0112612 A1
(43) Pub. Date: Apr. 30, 2009

(54) Board Document Approval Method

(76) Inventors: Alastair Mark Percival, Christchurch (NZ); Alessandro Sodi, Manhasset, NY (US); Robert Howard Craig, Asheboro, NC (US); Nicolas Jon Smith, Christchurch (NZ); Bert Matthijs Van Brakel, Christchurch (NZ); Christopher Roderick McLeod, Christchurch (NZ)

Correspondence Address: JOHN ALEXANDER GALBREATH, 2516 CHESTNUT WOODS CT, REISTERSTOWN, MD, 21136, US

(21) Appl. No.: 12/200,973

(22) Filed: Aug. 29, 2008

(30) Foreign Application Priority Data
Oct. 31, 2007 (NZ) 563034

(51) Int. Cl. G06Q 10/00; G06Q 90/00

(52) U.S. Cl. 705/1

(57) ABSTRACT

A computer implemented method for approving a board paper for distribution that includes the following steps in order:
A. The Board Document is received and converted to a digital document and allocated a first visual indicia;
B. The digital document is reviewed by a reviewer;
C. If the digital document is acceptable it is allocated a second visual indicia and step L is undertaken. If the digital document is not acceptable in its present form it is allocated a third visual indicia and step D is undertaken;
D. The digital document is amended by the originator of the Board Document;
E. Step C is repeated;
L. If any further reviews are necessary then step M is undertaken, if no further reviews are necessary then step W is undertaken;
M. The digital document is reviewed by a further reviewer, if the digital document is acceptable to the further reviewer it is allocated a further visual indicia and step N is undertaken, if the digital document is not acceptable and amendment is possible step D is repeated;
N. Is a further review needed, if it is then action step M, if not then action step W;
W. Allocate a final visual indicia.

### FIELD OF THE INVENTION

The present invention is a method of tracking the approval status of a board document.

### BACKGROUND

Directors on the boards of companies are required to consider and vote on various proposals; these proposals are normally presented in the form of documents called board papers. These papers are traditionally printed, collated and sent out to the directors some time before a meeting is convened to vote on the various board papers.

To prepare a board document for distribution it is often prepared as a proposal document which passes through one or more review and approval stages before being finally approved for distribution to the directors as a board paper. These board documents may be bound together with other support documents to form what is called a ‘board book’. One review that is often required is carried out by the Legal Department or a legal advisor, this review and approval often must occur first. With increasing legal ramifications attached to the decisions made by boards no distribution of the proposal can occur until the legal department/advisor signs it off. With traditional paper based systems, required for confidentiality and physical confirmation (for example a signature) of each step being completed, it can be difficult to track the progress of a board proposal. Without some form of tracking proposals can be delayed, and this delay can render these proposals untenable. For example an advertising campaign that needs to be commenced over a major holiday weekend for maximum impact may be ineffectual outside of this time period, thus devaluing the promotion.

Some tracking systems for board proposals can be time consuming to maintain or onerous to update or use. This can lead to the tracking system being ineffectual, or people just not bothering to use it, preferring an ad hoc approach.

Without inspecting a proposal document in detail it can sometimes be hard to determine if the required approvals have been obtained prior to distribution. If a proposal is distributed to the directors without the required approvals it can waste their valuable time and/or result in inappropriate decisions being made. If, for example a proposal that has significant legal ramifications is not approved by the legal advisor/legal department prior to distribution, and a decision to implement the proposal is made, it could result in embarrassment or even legal action.

### OBJECT OF THE INVENTION

It is therefore an object of this invention to provide a method by which the status of a board document can be determined which overcomes one or more of the deficiencies described above and/or provides a useful economical choice over present methods.

The present invention provides a computer implemented method for approving a board paper for distribution that includes the following steps in order:
A. The Board Document (1) is received and converted to a digital document (2) and allocated a first visual indicia (3);
B. The digital document (2) is reviewed by a reviewer (4);
C. If the digital document (2) is acceptable it is allocated a second visual indicia (5) and step L is undertaken. If the digital document (2) is not acceptable in its present form it is allocated a third visual indicia (6) and step D is undertaken;
D. The digital document (2) is amended by the originator (7) of the Board Document (1);
E. Step C is repeated;
L. If any further reviews are necessary then step M is undertaken, if no further reviews are necessary then step W is undertaken;
M. The digital document (2) is reviewed by a further reviewer (10,11,12), if the digital document (2) is acceptable to the further reviewer (10,11,12) it is allocated a further visual indicia (20,21,22) and step N is undertaken, if the digital document (2) is not acceptable and amendment is possible step D is repeated;
N. Is a further review needed, if it is then action step M, if not then action step W;
V. Allocate a final visual indicia (30).

Preferably the method is implemented as a sub routine or part of a larger computer program.

Preferably the first review (step B) is carried out by the Chairman of the board. In a highly preferred form the further reviewer (step M) is chosen from the group consisting of: a lawyer, a legal department, a chief financial officer, an environmental officer, a head of human resources, a human resources department, an information technology (IT) department, a head of IT, a consultant, a head of security and other board members.

In a highly preferred form the visual indicia is highlighting the file name or description of the digital document in one or more ways chosen from the list consisting of: colour, typestyle, typeface and animated effects. Preferably the typestyle is one or more selected from the group consisting of: bold, italic, superscript, subscript, underline, strikethrough, all capitals and no capitals. Preferably colour also includes the colour of the background colour of the text. Preferably the animated effect includes one or more effect selected from the group consisting of: flashing, moving highlighting or colour change of text, a repeated change from one typestyle to another and similar effects.

### DESCRIPTION OF THE DRAWINGS

By way of example only a preferred embodiment of the present invention will be described in detail with reference to the accompanying drawings in which:

FIG. 1 is a pictorial view of the method of approving a board document for distribution;

FIG. 2 is a flowchart of the method of approving a board paper for distribution;

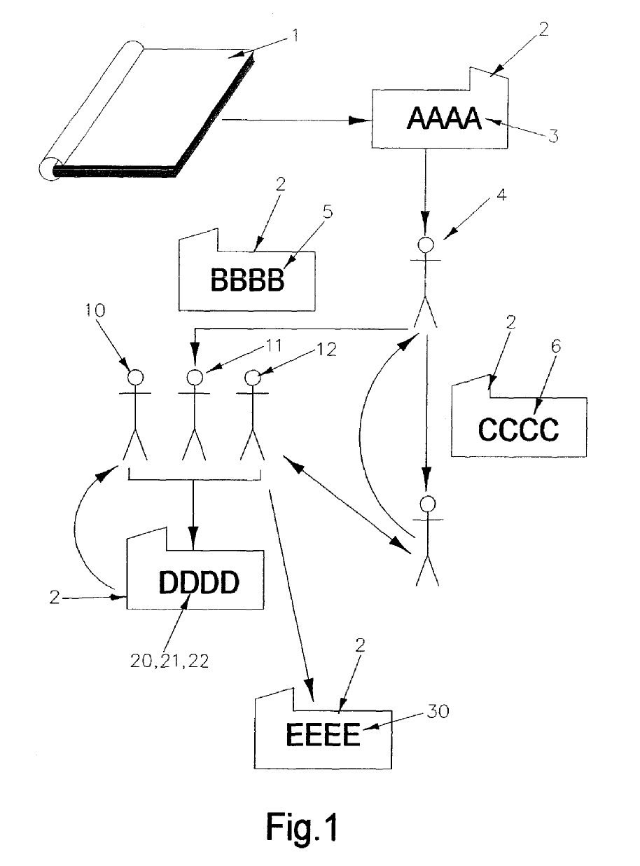

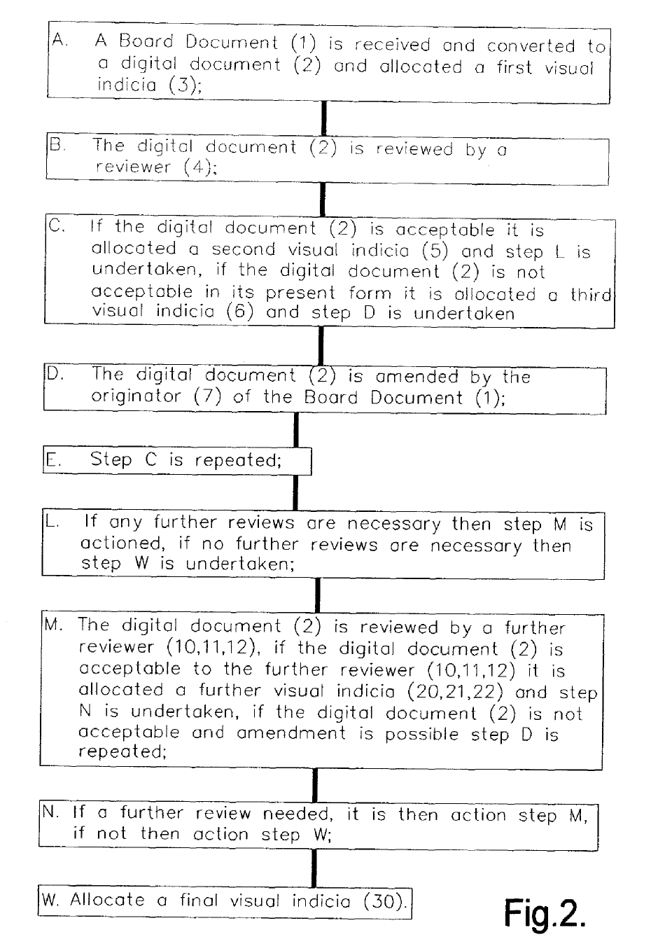

Referring to FIGS. 1 and 2 a method of approving a board paper for distribution is shown which includes the following steps in order:
A. A Board Document (1) is received and converted to a digital document (2) and allocated a first visual indicia (3);
B. The digital document (2) is reviewed by a reviewer (4);
C. If the digital document (2) is acceptable it is allocated a second visual indicia (5) and step L is undertaken, if the digital document (2) is not acceptable in its present form it is allocated a third visual indicia (6) and step D is undertaken;
D. The digital document (2) is amended by the originator (7) of the Board Document (1);
E. Step C is repeated;
L. If any further reviews are necessary then step M is undertaken, if no further reviews are necessary then step W is undertaken;
M. The digital document (2) is reviewed by a further reviewer (10,11,12), if the digital document (2) is acceptable to the further reviewer (10,11,12) it is allocated a further visual indicia (20,21,22) and step N is undertaken, if the digital document (2) is not acceptable and amendment is possible step D is repeated;
N. Is a further review needed, if it is then action step M, if not then action step W;
W. Allocate a final visual indicia (30).

In step A the board document (1), either in paper or an original electronic form, is converted to a digital document (2) in an acceptable electronic format such as pdf, xml, ppt, docx, rtf, doc, xls, xlsx, html, tif or similar. The digital document (2) is then allocated a first visual indicia (3), this visual indicia may be as simple as a computer program displaying the file name with one or more of the following features: a distinctive typeface, a distinctive colour, a specific icon, specific highlighting or a specific message shown when the mouse passes over the file name. This first visual indicia (3) makes it clear that the digital document (2) is in an acceptable digital format for further processing.

In step B this digital document (2) is checked by a reviewer (4), most likely to be the chairman of the board but could be the General Manager, Research Director or similar. This check may include relevance, alignment with present/future objectives and overall alignment with the company policies. The review would also include identifying any obvious lacks, areas that need to be clarified, missing figures and other information likely to be required by the board of directors considering the digital document (2).

In step C, if the reviewer (4) feels the digital document (2) is acceptable for further processing, they allocate it a second visual indicia (5) then step L is undertaken. The second visual indicia (5) may replace the first visual indicia (3) or be in addition to it, for example the first visual indicia (3) may be displaying the digital document's (2) name in a bold red typeface, and the second visual indicia (5) may be displaying the name in the same typeface but bold blue. Alternatively the second visual indicia (5) may be a graphical symbol such as a tick or cross appended to the end of the digital documents (2) name.

In step C, if the reviewer (4) does not feel the digital document (2) is complete or is otherwise not acceptable for further processing, the reviewer (4) will allocate a third visual indicia (6) to the digital document (2). The third visual indicia (6) is similar to the second visual indicia (5) in that it can replace or be added to the first visual indicia (2). Once the third visual indicia (5) has been allocated to the digital document (2) it is returned to the originator (7) of the board document (1) for amendment, if this is possible, and step D is undertaken. If no amendment is possible, or the board document (1 ) is not considered appropriate for the board to consider, then the digital document (2) proceeds no further.

In step D the digital document (2) is amended.

In step E, step C is repeated.

In step L a determination is made as to whether any further review of the digital document (2) is required, and if it is, step M is undertaken. If no further reviews are necessary then step W is undertaken.

In step M the digital document (2) is reviewed by a further reviewer (10,11,12), this review may be for example one of the following:
i. a review by the legal department to determine any legal ramifications if the proposal in the digital document (2) is accepted;
ii. a review by the financial department to consider if the financial analysis is robust;
iii. a review by the environmental department to determine the environmental impact of any proposal contained in the digital document (2);
iv. a review by a consultant to determine the security, industrial relations, political, infrastructure or similar effects of adopting the proposal contained within the digital document (2).

If the digital document (2) is accepted by the further reviewer (10,11,12) it is allocated a further visual indicia (20,21,22); which may replace or be in addition to any existing visual indicia (3,5,6) and step N is undertaken.

In step N, if further review is needed step M is repeated, if no further review is required then step W is undertaken.

In step W the digital document (2) is allocated a final visual indicia (30) to indicate that it is now in a form ready to be considered by the directors. The final visual indicia (30) may be in addition to any, or replace any or all, existing visual indicia (3,5,6,20,21,22).

The method is expected to be implemented as a machine readable computer program, or sub-routine, where the file name or description of the digital document (2) is displayed on a computer monitor of known type. The file name or description being displayed within the program with certain visual characteristics indicating its status.

The term visual indicia (3,5,6,20,21,22,30) includes typeface, typestyle, colours, graphical symbols or other visual cues such as flashing and colour gradients. Some of these visual indicia (3,5,6,20,21,22) may only be revealed when the name or description of the digital document (2) highlighted. The overall intention is to clearly display the status of the digital document (2) during the approval process on a computer monitor.

Blocks can be put in place to prevent a visual indicia (3,5,6,20,21,22,30) being allocated. These blocks may be to prevent those not authorised from circumventing the authorisation process or to track who approved the digital document (2) at each stage. These blocks may require passwords, a specific IP address or MAC code, a specific machine, smart cards or other dongles be used to remove them, thus allow a specific visual indicia (3,5,6,20,21,22,30) to be allocated.

Any discussion of the prior art throughout the specification is not an admission that such prior art is widely known or forms part of the common general knowledge in the field.

1. A computer implemented method for approving a board paper for distribution that includes the following steps in order:
A. The Board Document is received and converted to a digital document and allocated a first visual indicia;
B. The digital document is reviewed by a reviewer;
C. If the digital document is acceptable it is allocated a second visual indicia and step L is undertaken. If the digital document is not acceptable in its present form it is allocated a third visual indicia and step D is undertaken;
D. The digital document is amended by the originator of the Board Document;
E. Step C is repeated;
O. If any further reviews are necessary then step M is undertaken, if no further reviews are necessary then step W is undertaken;
P. The digital document is reviewed by a further reviewer, if the digital document is acceptable to the further reviewer it is allocated a further visual indicia and step N is undertaken, if the digital document is not acceptable and amendment is possible step D is repeated;
Q. Is a further review needed, if it is then action step M, if not then action step W;
W. Allocate a final visual indicia.

2. The method as claimed in claim 1 characterised in that the method is implemented as a sub routine or part of a larger computer program.

3. The method as claimed in claim 1 characterised in that the first review (step B) is carried out by the Chairman of the board.

4. The method as claimed in claim 1 characterised in that the further reviewer (step M) is chosen from the group consisting of: a lawyer; a legal department; a chief financial officer; an environmental officer; a head of human resources; a human resources department; an information technology (IT) department; a head of IT; a consultant; a head of security and other board members.

5. The method as claimed in claim 1 characterised in that the visual indicia is highlighting a file name or description of the digital document in one or more ways chosen from the list consisting of: colour; typestyle; typeface and animated effects.

6. The method as claimed in claim 1 characterised in that the visual indicia is highlighting the file name or description of the digital document by using one or more typestyle selected from the group consisting of: bold; italic; superscript; subscript; underline; strikethrough; all capitals and no capitals.

7. The method as claimed in claim 1 characterised in that the visual indicia is highlighting the file name or description of the digital document in colour, the text, background or both.

8. The method as claimed in claim 1 characterised in that the visual indicia is highlighting the file name or description of the digital document by adding one or more animated effect selected from the group consisting of: flashing; moving highlighting or colour change of text; a repeated change from one typestyle to another and similar effects.
